(19) United States
(12) Patent Application Publication
(10) Pub. No.: US 2017/0088479 A1
(43) Pub. Date: Mar. 30, 2017

(54) METHOD OF INCREASING ABIOTIC STRESS RESISTANCE OF A PLANT

(71) Applicant: Bayer CropScience LP, Research Triangle Park, NC (US)

(72) Inventors: Magalie GUILHABERT, Davis, CA (US); Hong ZHU, West Sacramento, CA (US)

(21) Appl. No.: 15/287,647

(22) Filed: Oct. 6, 2016

Related U.S. Application Data
(63) Continuation of application No. 14/015,464, filed on Aug. 30, 2013, now abandoned.
(60) Provisional application No. 61/696,046, filed on Aug. 31, 2012.
(60) Provisional application No. 61/715,780, filed on Oct. 18, 2012.
(60) Provisional application No. 61/792,355, filed on Mar. 15, 2013.

(51) Int. Cl. C05F 11/00; C05F 11/08; C05G 3/00

(52) U.S. Cl. CPC C05F 11/00; C05G 3/00; C05F 11/08

(57) ABSTRACT

The invention relates to a method of increasing abiotic stress resistance enhancing soil nutrition of a plant, the method comprising applying a composition comprising Bacillus subtilis or Bacillus pumilus or a mutant thereof, to the plant, to a part of the plant and/or to an area around the plant or plant part. The invention also is directed to a method of enhancing soil nutrition comprising applying a composition comprising Bacillus subtilis or a mutant thereof to the soil.

### CROSS-REFERENCE TO RELATED APPLICATIONS

This application claims priority to and is a continuation of U.S. patent application Ser. No. 14/015,464, filed Aug. 30, 2013, now pending, which in turn claims the benefit under 35 U.S.C. Section 119(e) of U.S. Provisional Patent Application No. 61/696,046, filed Aug. 31, 2012, U.S. Provisional Patent Application No. 61/715,780, filed Oct. 18, 2012, and U.S. Provisional Patent Application No. 61/792,355, filed Mar. 15, 2013. Each of the foregoing applications is hereby incorporated by reference in its entirety.

### TECHNICAL FIELD

This invention relates to the technical field of increasing abiotic stress resistance of a plant and to the enhancement of nutritional levels within the soil.

### BACKGROUND

In order to promote plant growth, development and yield, fertilizers are employed worldwide, based on both inorganic and organic substances. A further major factor limiting plant growth and productivity is abiotic stress, such as drought stress, salinity stress, nutrient deficiency, contamination with heavy metals, extreme temperatures or floods. For example, exposure to salt stress, drought conditions or nutrient deficiency generally causes a decrease in yields of plant material, seeds, fruit and other edible products. Crop losses and crop yield losses of major crops such as rice, maize (corn) and wheat as well as forest trees caused by these stresses represent a significant economic and political factor and contribute to food shortages in many developing countries. Developing methods that render plants, for instance, salt stress-tolerant and/or resistant is a strategy that has the potential to solve or mediate at least some of these problems. Moreover, methods of enhancing soil nutrition and releasing plant nutrients from organic material could increase plant growth and alleviate environmental stress on plants.

There thus exists a continuing need to provide ways to render plants tolerant and/or resistant to abiotic stress and to enhance soil nutrients available to plants. It is an object of the present invention to provide a method to confer or increase abiotic stress tolerance and/or resistance to plants and to increase the availability of plant nutrients in the soil.

### SUMMARY

The present invention provides a method of increasing abiotic stress resistance of a plant. The method includes applying a composition to at least one of the plant, a part of the plant, an area around the plant and an area around the plant part. Typically the method includes providing the composition. The composition includes Bacillus subtilis or Bacillus pumilus. In some embodiments Bacillus subtilis or Bacillus pumilus included in the composition is a mutant of a known strain of Bacillus subtilis or of Bacillus pumilus.

In certain embodiments, the invention provides a method of increasing abiotic stress resistance of a plant, the method comprising applying a composition comprising Bacillus subtilis to the plant, to a part of the plant and/or to an area around the plant or plant part in an amount sufficient to increase abiotic stress resistance of the plant.

According to some particular embodiments the Bacillus subtilis is B. subtilis QST713, deposited as NRRL Accession No. B-21661, or a mutant thereof. In some embodiments Bacillus subtilis is the B. subtilis strain QST30002 or the B. subtilis strain QST30004, deposited as Accession Nos. NRRL B-50421 and NRRL B-50455, respectively, or a mutant thereof. In other embodiments the Bacillus pumilus strain is B. pumilus 2808 which is deposited as Accession No. NRRL B-30087 and is described in International Patent Publication No. WO 2000/058442. According to some other particular embodiments, the abiotic stress may be salt stress or nutrient deficiency. The salt stress may include increased salt concentration or drought. The nutrient deficiency may be lack of a soil nutrient such as potassium, phosphate or iron in an area of soil around the plant. The increase of stress resistance against (soil) nutrient deficiency such as phosphate may be provided by an improved solubilization of nutrients that are deficient in the soil. The area around a plant or plant part, which may also be around a fruit, may be or include the locus where the plant is growing, or a part of that locus. The respective area around a plant or plant part may for example be or include matter such as soil that is located in the vicinity to the plant or plant part. The respective area around a fruit may for example be or include a portion of a plant on which the fruit is growing, or be or include matter such as soil that is located in the vicinity to the plant or plant part carrying the fruit. In some embodiments the method includes applying the composition to soil. The composition and the soil may be contacted with the plant independently. In some embodiments the soil comes into contact with the plant or plant part before the composition is applied. In some embodiments the composition is applied before the plant or plant part comes into contact with the soil. In some embodiments the composition is applied while the plant or plant part comes into contact with the soil.

Following exposure to the composition the increase in abiotic stress resistance such as salt stress resistance or nutrient deficiency resistance is effective for at least about 2 weeks. In some embodiments salt stress resistance is increased for at least about a month. Salt stress resistance of a plant exposed to the composition is in some embodiments increased for at least about 2 months, including for at least about 3 months, for at least about 4 months, for at least about 5 months, for at least about 6 months, for at least about 7 months, for at least about 8 months, at least about 9 months, at least about 10 months or for at least about 11 months. In some embodiments salt stress resistance of a respective plant is increased for at least about a year, including for at least about 1½ years after application or longer.

The method of the present invention includes applying the composition at any time during the life cycle of a plant, during one or more stages of a plant's life cycle, or at regular intervals of a plant's life cycle, or continuously throughout the life of the plant. Hence the composition may be applied as required. The composition may for example be applied to a plant during growth, before and/or during blossom and/or before and/or during the occurrence of seeds. As an illustrative example, the composition can be applied before, during and/or shortly after the plants are transplanted from one location to another, such as from a greenhouse or hotbed to the field. In another example, the composition can be applied shortly after seedlings emerge from the soil or other growth media (e.g., vermiculite). As yet another example, a composition can be applied at any time to plants grown hydroponically. A method according to the invention may include applying the composition on a plant, on a plant part, on an area around a plant, including proximate to a plant, on a fruit and/or an area around, including proximate to, a fruit multiple times, for example a preselected number of times during a desired period of time. In some embodiments a respective composition may be applied on plants for multiple times with desired interval period.

In a method according to the invention the composition is applied to a plant, to a plant part, to an area around a plant or plant part, to the fruit, to a plant carrying the fruit and/or to an area around a fruit. An area around a fruit, a plant or a plant part may for example be an area within about 2 meters, within about a meter, within about 70 cm, within about 50 cm, within about 25 cm, within about 10 cm or within about 5 cm surrounding the plant, the plant part or the fruit.

In a related aspect the present invention relates to the use of Bacillus subtilis or Bacillus pumilus for increasing salt stress resistance of a plant. The use includes applying a composition to at least one of the plant, a part of the plant, an area around the plant and an area around the plant part. In some embodiments Bacillus subtilis or Bacillus pumilus are included in a composition.

According to another embodiment, the present invention relates to a method of enhancing soil nutrition comprising applying a composition comprising Bacillus subtilis to the soil. The composition may facilitate biodegradation of organic materials with a hydrolytic enzyme selected from a proteinase, a cellulase, and a xylanase. In one embodiment, the invention provides a method of enhancing soil nutrition comprising applying a composition comprising Bacillus subtilis to the soil in an amount sufficient to enhance soil nutrition.

In a related aspect, the present invention relates to a method of facilitating biodegradation of organic material, the method comprising applying Bacillus subtilis to the organic material in an amount sufficient to facilitate biodegradation of the organic material with a hydrolytic enzyme.

### BRIEF DESCRIPTION OF THE DRAWINGS

FIG. 1 depicts rice plants treated with water or SERENADE SOIL® and irrigated with salt at 60 mM for 14 days.

FIG. 2 depicts the roots of rice plants treated with water or SERENADE SOIL® and irrigated with salt at 60 mM for 14 days (64 oz/acre equals 0.448 g/m²).

FIG. 3 depicts rice plants treated with water or SONATA® and irrigated with salt at 60 mM for 14 weeks.

FIG. 4 depicts the roots of rice plants treated with water or SERENADE SOIL® or SONATA® and irrigated with salt at 60 mM for 14 days (64 oz/acre equals 0.448 g/m²).

FIG. 5 depicts root and shoot dry weights in mg of plants treated with SERENADE ASO® and plants treated with water.

FIG. 6A depicts levels of soluble phosphate resulting from cultivation of the phosphate solubilisation by Bacillus subtilis strain AQ713 grown in NBRIY medium compared to the blank medium, and FIG. 6B depicts levels of soluble phosphate resulting from cultivation of the phosphate solubilisation by Bacillus subtilis strain AQ30002 grown in NBRIY medium compared to the blank medium.

FIG. 7 shows the alignment of various swrA genomic DNA encompassing the predicted swrA transcript. Bsub_168=B. subtilis strain 168; Bsub_3610=B. subtilis strain 3610; QST713=QST713 wild type; AQ30002 and AQ30004=representative strains of the present invention; Bamy_FZB42=B. amyloliquefaciens strain FZB42; Bpum_SAFR-032=B. pumilus strain SAFR-032; and Blic_14580=B. licheniformis strain 14580.

FIG. 8 shows the alignment of various swrA genomic DNA encompassing the predicted swrA transcript. Abbreviations have the same swrA meanings as in FIG. 7, and Batr_1942=B. atrophaeus strain 1942 and Bpum_2808=B. pumilus strain 2808.

FIG. 9 shows the alignment of various proteins obtained from their predicted swrA transcripts. Abbreviations have the same meaning as in FIGS. 7 and 8, and Bpum_7061=B. pumilus 7061.

### DETAILED DESCRIPTION

Unless defined otherwise, all technical and scientific terms used herein have the same meaning as commonly understood by one of ordinary skill in the art to which this invention belongs.

As used herein, the term “plant” refers to any living organism belonging to the kingdom Plantae (i.e., any genus/species in the Plant Kingdom). This includes familiar organisms such as but not limited to trees, herbs, bushes, grasses, vines, ferns, mosses and green algae. The term refers to both monocotyledonous plants, also called monocots, and dicotyledonous plants, also called dicots. The plant is in some embodiments of economic importance. In some embodiments the plant is a men-grown plant, for instance a cultivated plant, which may be an agricultural, a silvicultural or a horticultural plant. Examples of particular plants include but are not limited to corn, potatoes, roses, apple trees, sunflowers, wheat, rice, bananas, tomatoes, opo, pumpkins, squash, lettuce, cabbage, oak trees, guzmania, geraniums, hibiscus, clematis, poinsettias, sugarcane, taro, duck weed, pine trees, Kentucky blue grass, zoysia, coconut trees, brassica leafy vegetables (e.g., broccoli, broccoli raab, Brussels sprouts, cabbage, Chinese cabbage (Bok Choy and Napa), cauliflower, cavalo, collards, kale, kohlrabi, mustard greens, rape greens, and other brassica leafy vegetable crops), bulb vegetables (e.g., garlic, leek, onion (dry bulb, green, and Welch), shallot, and other bulb vegetable crops), citrus fruits (e.g., grapefruit, lemon, lime, orange, tangerine, citrus hybrids, pummelo, and other citrus fruit crops), cucurbit vegetables (e.g., cucumber, citron melon, edible gourds, gherkin, muskmelons (including hybrids and/or cultivars of cucumis melons), water-melon, cantaloupe, and other cucurbit vegetable crops), fruiting vegetables (including eggplant, ground cherry, pepino, pepper, tomato, tomatillo, and other fruiting vegetable crops), grape, leafy vegetables (e.g., romaine), root/tuber and corm vegetables (e.g., potato), and tree nuts (almond, pecan, pistachio, and walnut), berries (e.g., tomatoes, barberries, currants, elderberryies, gooseberries, honeysuckles, mayapples, nannyberries, Oregon-grapes, see-buckthorns, hackberries, bearberries, lingonberries, strawberries, sea grapes, lackberries, cloudberries, loganberries, raspberries, salmonberries, thimbleberries, and wineberries), cereal crops (e.g., corn, rice, wheat, barley, sorghum, millets, oats, ryes, triticales, buckwheats, fonio, and quinoa), pome fruit (e.g., apples, pears), stone fruits (e.g., coffees, jujubes, mangos, olives, coconuts, oil palms, pistachios, almonds, apricots, cherries, damsons, nectarines, peaches and plums), vine (e.g., table grapes, wine grapes), fibber crops (e.g., hemp, cotton), ornamentals, to name a few. The plant may in some embodiments be a household/domestic plant, a greenhouse plant, an agricultural plant, or a horticultural plant. As already indicated above, in some embodiments the plant may a hardwood such as one of acacia, eucalyptus, hornbeam, beech, mahogany, walnut, oak, ash, willow, hickory, birch, chestnut, poplar, alder, maple, sycamore, ginkgo, a palm tree and sweet gum. In some embodiments the plant may be a conifer such as a cypress, a Douglas fir, a fir, a sequoia, a hemlock, a cedar, a juniper, a larch, a pine, a redwood, spruce and yew. In some embodiments the plant may be a fruit bearing woody plant such as apple, plum, pear, banana, orange, kiwi, lemon, cherry, grapevine, papaya, peanut, and fig. In some embodiments the plant may be a woody plant such as cotton, bamboo and a rubber plant. The plant may in some embodiments be an agricultural, a silvicultural and/or an ornamental plant, i.e., a plant which is commonly used in gardening, e.g., in parks, gardens and on balconies. Examples are turf, geranium, pelargonia, petunia, begonia, and fuchsia, to name just a few among the vast number of ornamentals. The term “plant” is also intended to include any plant propagules.

The term “plant” generally includes a plant that has been modified by one or more of breeding, mutagenesis and genetic engineering. Genetic engineering refers to the use of recombinant DNA techniques. Recombinant DNA techniques allow modifications which cannot readily be obtained by cross breeding under natural circumstances, mutations or natural recombination. In some embodiments a plant obtained by genetic engineering may be a transgenic plant.

As used herein, the term “plant part” refers to any part of a plant including but not limited to the shoot, root, stem, seeds, stipules, leaves, petals, flowers, ovules, bracts, branches, petioles, internodes, bark, wood, tubers, pubescence, tillers, rhizomes, fronds, blades, pollen, stamen, microspores, fruit and seed. The two main parts of plants grown in typical media employed in the art, such as soil, are often referred to as the “above-ground” part, also often referred to as the “shoots”, and the “below-ground” part, also often referred to as the “roots”.

In a method according to the invention the composition can be applied to any plant or any part of any plant grown in any type of media used to grow plants (e.g., soil, vermiculite, shredded cardboard, and water) or applied to plants or the parts of plants grown aerially, such as orchids or staghorn ferns. The composition may for instance be applied by spraying, atomizing, vaporizing, scattering, dusting, watering, squirting, sprinkling, or pouring. As already indicated above, application may be carried out at any desired location where the plant of interest is positioned, such as agricultural, horticultural, forest, plantation, orchard, nursery, organically grown crops, turfgrass and urban environments.

The present invention provides a method of using a composition that includes Bacillus subtilis and/or Bacillus pumilus, a fermentation product of Bacillus subtilis and/or Bacillus pumilus or a cell free extract of Bacillus subtilis and/or Bacillus pumilus for increasing salt stress resistance of a plant. Bacillus subtilis and Bacillus pumilus are Gram-positive soil bacteria, which are often found in the plant rhizosphere. B. subtilis, like many species of bacteria, can exhibit two distinct modes of growth, a free-swimming, planktonic mode of growth and a sessile biofilm mode in which an aggregate of cells secrete an extracellular matrix to adhere to each other and/or to a surface. The pathways utilized by bacteria such as B. subtilis to build biofilms are extremely diverse, varying enormously within and among different species and under different environment conditions. It has recently been recognized that biofilm formation by specific strains of B. subtilis, B. pumilus and related species may help control infection caused by plant pathogens.

The composition that includes Bacillus subtilis and/or Bacillus pumilus may be a liquid, a slurry, a wettable powder, a granule, flowable, whether dry or aqueous, or a microencapsulation in a suitable medium.

Bacillus subtilis and Bacillus pumilus may be present in compositions used in the present invention as spores (which are dormant), as vegetative cells (which are growing), as transition state cells (which are transitioning from growth phase to sporulation phase) or as a combination of all of these types of cells. In some embodiments a respective composition includes, including essentially consists of and consists of, mainly spores. In other embodiments, the composition includes spores and metabolites produced by the cells during fermentation before they sporulate.

In some embodiments Bacillus subtilis is Bacillus subtilis strain QST713. Bacillus subtilis strain QST713 is a naturally occurring widespread bacterium that can be used to control plant diseases including blight, scab, gray mold, and several types of mildew. Regulatory authorities in the USA and Europe have classified Bacillus subtilis QST713 as displaying no adverse effects on humans or the environment. The bacterium, Bacillus subtilis, is prevalent in soils and has been found in a variety of habitats worldwide. The QST713 strain of Bacillus subtilis is known to be antagonistic towards many fungal plant pathogens.

Wild type Bacillus subtilis QST713, its mutants, its supernatants, and its lipopeptide metabolites, and methods for their use to control plant pathogens and insects are fully described in U.S. Pat. Nos. 6,060,051; 6,103,228; 6,291,426; 6,417,163; and 6,638,910; each of which is specifically and entirely incorporated by reference herein for everything it teaches. In these U.S. Patents, the strain is referred to as AQ713, which is synonymous with QST713. Any references in this specification to QST713 refer to Bacillus subtilis QST713 (aka AQ713) as present in the SERENADE® products, deposited under NRRL Accession No. B21661, or prepared in bioreactors under conditions that simulate production of the SERENADE® product.

At the time of filing U.S. patent application Ser. No. 09/074,870 in 1998, which corresponds to the above patents, the strain was designated as Bacillus subtilis based on classical, physiological, biochemical and morphological methods. Taxonomy of the Bacillus species has evolved since then, especially in light of advances in genetics and sequencing technologies, such that species designation is based largely on DNA sequence rather than the methods used in 1998. After aligning protein sequences from B. amyloliquefaciens FZB42, B. subtilis 168 and QST713, approximately 95% of proteins found in B. amyloliquefaciens FZB42 are 85% or greater identical to proteins found in QST713; whereas only 35% of proteins in B. subtilis 168 are 85% or greater identical to proteins in QST713. However, even with the greater reliance on genetics, there is still taxonomic ambiguity in the relevant scientific literature and regulatory documents, reflecting the evolving understanding of Bacillus taxonomy over the past 15 years. For example, a pesticidal product based on B. subtilis strain FZB24, which is as closely related to QST713 as FZB42, is classified in documents of the U.S. EPA as B. subtilis var. amyloliquefaciens. Due to these complexities in nomenclature, this particular Bacillus species is variously designated, depending on the document, as B. subtilis, B. amyloliquefaciens, and B. subtilis var. amyloliquefaciens. Therefore, we have retained the B. subtilis designation of QST713 rather than changing it to B. amyloliquefaciens, as would be expected currently based solely on sequence comparison and inferred taxonomy.

Bacillus subtilis strain QST713 has been deposited with the NRRL on 7 May 1997 under the provisions of the Budapest Treaty on the International Recognition of the Deposit of Microorganisms for the Purpose of Patent Procedure under Accession Number B21661. NRRL is the abbreviation for the Agricultural Research Service Culture Collection, an international depositary authority for the purposes of deposing microorganism strains under the Budapest Treaty on the International Recognition of the Deposit of Microorganisms for the Purposes of Patent Procedure, having the address National Center for Agricultural Utilization Research, Agricultural Research Service, U.S. Department of Agriculture, 1815 North University Street, Peoria, Ill. 61604, U.S.A. Suitable formulations of the Bacillus subtilis strain QST713 are commercially available under the tradenames SERENADE®, SERENADE® ASO, SERENADE SOIL® and SERENADE® MAX from Bayer CropScience LP, North Carolina, U.S.A.

The SERENADE® product (U.S. EPA Registration No. 69592-12) contains a patented strain of Bacillus subtilis (strain QST713) and many different lipopeptides that work synergistically to destroy disease pathogens and provide superior antimicrobial activity. The SERENADE® product is used to protect plants such as vegetables, fruit, nut and vine crops against diseases such as Fire Blight, Botrytis, Sour Rot, Rust, Sclerotinia, Powdery Mildew, Bacterial Spot and White Mold. The SERENADE® products are available as either liquid or dry formulations which can be applied as a foliar and/or soil treatment. Copies of U.S. EPA Master Labels for SERENADE® products, including SERENADE® ASO, SERENADE® MAX, and SERENADE SOIL®, are publicly available through National Pesticide Information Retrieval System's (NPIRSv) USEPA/OPP Pesticide Product Label System (PPLS).

SERENADE® ASO (Aqueous Suspension-Organic) contains 1.34% of dried QST713 as an active ingredient and 98.66% of other ingredients. SERENADE® ASO is formulated to contain a minimum of 1×10⁹ cfu/g of QST713 while the maximum amount of QST713 has been determined to be 3.3×10¹⁰ cfu/g. Alternate commercial names for SERENADE® ASO include SERENADE® BIOFUNGICIDE, SERENADE SOIL® and SERENADE GARDEN® DISEASE. For further information, see the U.S. EPA Master Labels for SERENADE® ASO dated Jan. 4, 2010, and SERENADE SOIL®, each of which is incorporated by reference herein in its entirety.

SERENADE® MAX contains 14.6% of dried QST713 as an active ingredient and 85.4% of other ingredients. SERENADE® MAX is formulated to contain a minimum of 7.3×10⁹ cfu/g of QST713 while the maximum amount of QST713 has been determined to be 7.9×10¹⁰ cfu/g. For further information, see the U.S. EPA Master Label for SERENADE® MAX, which is incorporated by reference herein in its entirety.

As explained in detail in International Patent Application No. WO2012/087980, cultures of B. subtilis QST713 are actually a mixture of wild type cells and a relatively small percentage of variant cell types which have been designated as “sandpaper cells”, based on the morphology of their colonies. Thus, QST713 as found in the SERENADE® products or as found in QST713 cells grown in a bioreactor consists of a mixed population of wild type cells and these sandpaper cells at the same or similar ratios found in the SERENADE® product. These sandpaper cells form colonies on nutrient agar that morphologically and physiologically appear highly compacted, hydrophobic, flat, dry, and very “crispy” and are very hard to remove from the agar. Cell adherence may be observed qualitatively or may be measured by crystal violet staining In addition to this distinct colony morphology on nutrient agar, sandpaper cells form dense, compact biofilms (or more robust biofilms) on surfaces such as roots. In accordance with the above disclosure, the B. subtilis strain AQ30002 (aka QST30002) or AQ30004 (aka QST30004), deposited as Accession Nos. NRRL B-50421 and NRRL B-50455 which are described in International Patent Publication No. WO2012/087980 or mutants of these B. subtilis strains having all of the physiological and morphological characteristics of B. subtilis strain AQ30002 (aka QST30002) or AQ30004 (aka QST30004) can also be used in the method of the invention, either alone or in mixture with other Bacillus subtilis strains such as B. subtilis QST713.

“Wild type” refers to the phenotype of the typical form of a species as it occurs in nature and/or as it occurs in a known isolated form which has previously been designated as the “wild type.” Synonyms for “wild type” recognized herein include “wildtype,” “wild-type,” “⁺” and “wt”. The wild type is generally conceptualized as a product of the standard, “normal” allele of a specific gene(s) at one or more loci, in contrast to that produced by a non-standard, “mutant” or “variant” allele. In general, and as used herein, the most prevalent allele (i.e., the one with the highest gene frequency) of a particular Bacillus strain or isolate is the one deemed as the wild type. As used herein, “QST713 wild type” or “QST713 wild type swrA⁺” and synonyms thereof (e.g., “QST713 swrA⁺, “QST wildtype,” “QST713 wt,” etc.) refer to B. subtilis QST713 with a functional swrA gene (i.e., swrA+) that is able to express the encoded swrA protein. Thus, these terms refer to clonal wild type QST713 cells which are 100% swrA⁺.

As mentioned above, in some embodiments the Bacillus subtilis strain is B. subtilis AQ30002 or B. subtilis AQ30004. In other embodiments the Bacillus subtilis strain is B. subtilis 3610. In some embodiments the Bacillus pumilus strain is B. pumilus SAFR-032. In some embodiments the Bacillus pumilus strain is B. pumilus 2808 which is deposited as Accession No. NRRL B-30087 and is described in U.S. Pat. Nos. 6,245,551 and 6,586,231 and in International Patent Publication No. WO2000/058442. Suitable formulations of the Bacillus pumilis strain 2808 are available under the tradename SONATA® from Bayer CropScience LP, North Carolina, U.S.A.

Generally speaking, a composition used in the present invention can be any fermentation broth of Bacillus subtilis, Bacillus pumilus or a mutant thereof. The term “fermentation broth” (which can also be called “whole broth culture” or “whole broth”) as used herein, refers to the culture medium resulting after fermentation of a microorganism and encompasses the microorganism used herein (i.e., Bacillus subtilis, Bacillus pumilus or a mutant thereof) and its component parts, unused raw substrates, and metabolites produced by the microorganism during fermentation, among other things. Bacillus subtilis and Bacillus pumilus are both spore-forming bacteria. In one aspect, these fermentation broths thus include spore-forming bacterial cells, their metabolites and residual fermentation broth. In other aspects, spore-forming bacterial cells of the fermentation broths are largely spores. In another aspect, the compositions comprising fermentation broths further comprise formulation inerts and formulation ingredients. In some embodiments, the fermentation broth is washed, for example, via a diafiltration process, to remove residual fermentation broth and metabolites so that the fermentation product is largely spores. The bacterial cells, spores and metabolites in culture media resulting from fermentation may be used directly or concentrated by conventional industrial methods, such as centrifugation, tangential-flow filtration, depth filtration, and evaporation. In another embodiment the fermentation broth or concentrated fermentation broth is dried using conventional drying processes or methods such as spray drying, freeze drying, tray drying, fluidized-bed drying, drum drying, or evaporation to create a fermentation solid. The term “fermentation product,” as used herein, refers to whole broth, broth concentrate and/or fermentation solids.

In some embodiments the composition includes a mutant of a particular strain of Bacillus subtilis or Bacillus pumilus, such as Bacillus subtilis QST713 or Bacillus pumilus QST2808. The term “mutant” refers to a genetic variant derived from QST713 or QST2808. In one embodiment, the mutant has one or more or all the identifying (functional) characteristics of a parent strain, such as QST713 or QST2808. In another embodiment, the mutant or a fermentation product thereof increases abiotic stress resistance of a plant (as an identifying functional characteristic) at least as well as the parent strain. Such mutants may be genetic variants having a genomic sequence that has greater than about 85%, greater than about 90%, greater than about 95%, greater than about 98%, or greater than about 99% sequence identity to the parent strain. Mutants may be obtained by treating parent strain cells with chemicals or irradiation or by selecting spontaneous mutants from a population of parent strain cells (such as phage resistant or antibiotic resistant mutants) or by other means well known to those practiced in the art.

In some embodiments, the composition includes Bacillus cells with a mutation in the swrA gene (i.e., swrA⁻ cells) such as those described in International Patent Publication No. WO2012/087980. International Patent Pubication No. WO2012/087980 also describes several methods of generating swrA⁻ cells in Bacillus cells. In one embodiment, the mutation in the swrA gene is at a position corresponding to one or more of positions 26-34 of the swrA gene set forth as SEQ ID NO. 1 or at a position corresponding to one or more of positions 1-3 of the swrA gene set forth as SEQ ID NO. 1. In one variation, the mutation is an insertion or deletion.

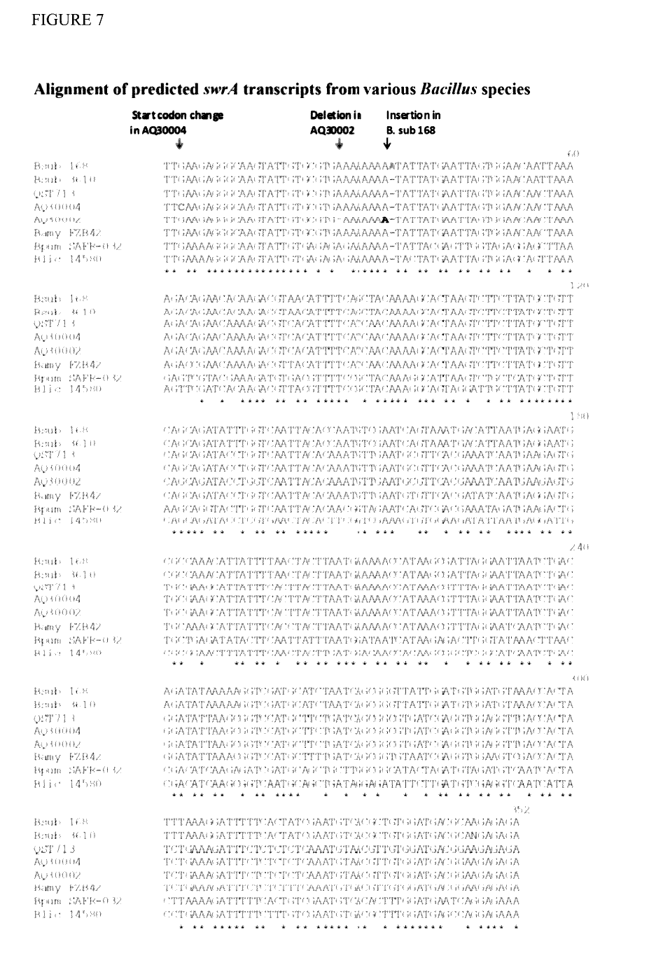

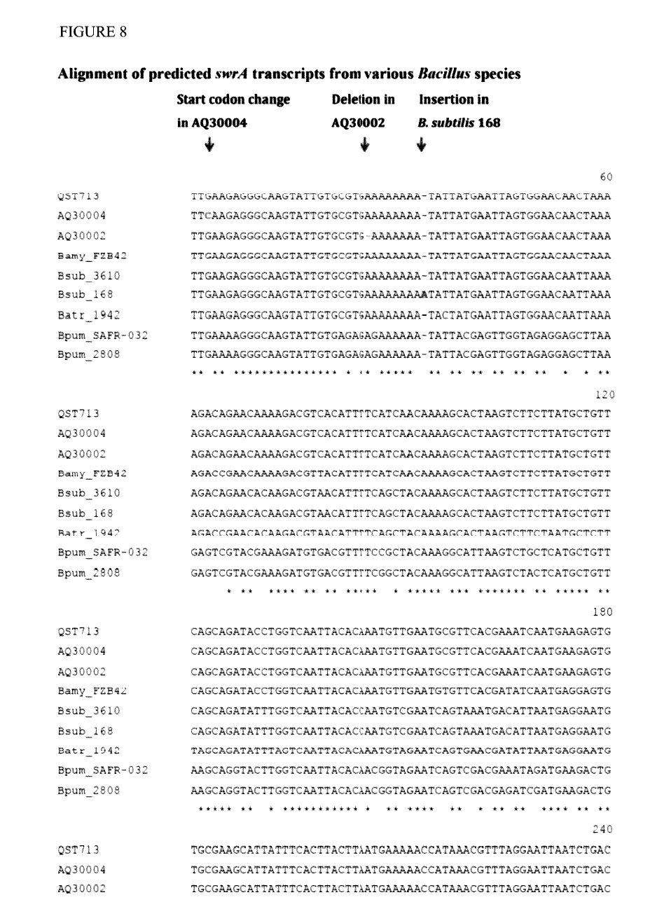

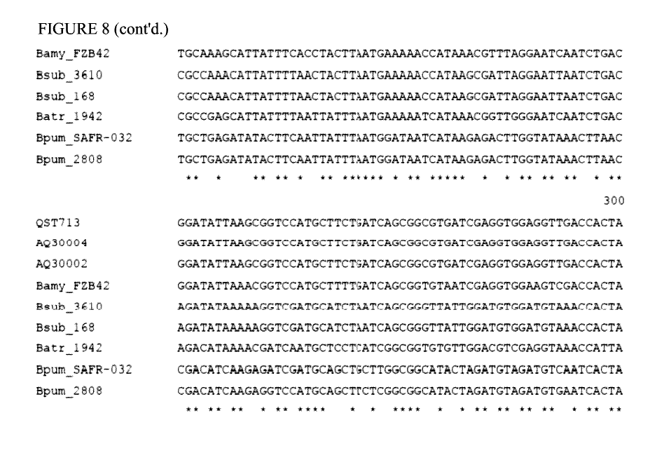

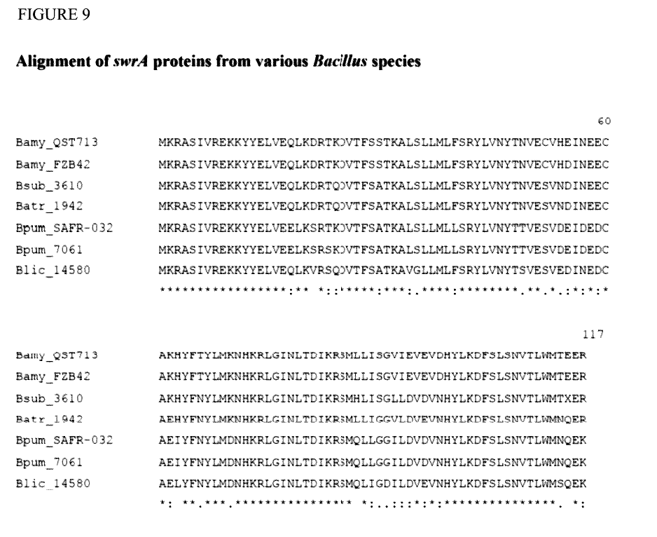

The sequence listing provided with this application provides sequences for the swrA gene from various Bacillus species and strains, as also shown in FIGS. 7, 8 and 9. Table 1 below correlates SEQ ID NOS. with strains. All sequences are nucleotide sequences, except SEQ ID NO. 2, which is an amino acid sequence.

TABLE 1

| SEQUENCE ID NO. | STRAIN |
|---|---|
| 1, 11, 12 and 13 | B. subtilis QST713 |
| 2 | B. subtilis QST713 |
| 3 | B. subtilis AQ30002 |
| 4 | B. subtilis AQ30004 |
| 5 | B. amyloliquefaciens FZB42 |
| 6 | B. pumilus SAFR-032 |
| 7 | B. subtilis 3610 |
| 8 | B. pumilus 2808 |
| 9 | B. atrophaeus 1942 |
| 10 | B. licheniformis 14580 |

In some embodiments, swrA activity has been reduced by means other than mutation of the swrA gene. swrA activity may be reduced by various agents, including small molecules, drugs, chemicals, compounds, siRNA, ribozymes, antisense oligonucleotides, swrA inhibitory antibodies, swrA inhibitory peptides, aptamers or mirror image aptamers. In one embodiment the mutation in the swrA gene in the swrA⁻ cells is at a position corresponding to one or more of positions 26-34 of the swrA gene set forth as SEQ ID NO. 1 or at a position corresponding to one or more of positions 1-3 of the swrA gene set forth as SEQ ID NO. 1. In one variation, the mutation is an insertion or deletion. In another aspect the swrA⁻ cells are the result of a knock-out of the swrA gene.

In one embodiment, the spore-forming bacterial cells of the present invention are Bacillus subtilis QST713 bacterial cells having a mutation in the swrA gene and compositions thereof. In one aspect, the Bacillus subtilis QST713 bacterial cells comprise at least one nucleic acid base pair change in a start codon and/or at least one nucleic acid base pair insertion or deletion in a swrA gene. In other aspects, the insertion or deletion in the swrA gene occurs at one or more of the base pairs at positions 26-34 of SEQ ID NO. 1. In yet another aspect, the swrA⁻ cells of Bacillus subtilis QST713 are selected from the group consisting of the strain AQ30002 (aka QST30002) and the strain AQ30004 (aka QST30004), deposited as Accession Numbers NRRL B-50421 and NRRL B-50455, respectively. In still another aspect of the invention, the Bacillus subtilis QST713 having the mutation in the swrA gene is wildtype for epsC, sfp and degQ. In another aspect the Bacillus subtilis QST713 having the mutation is otherwise isogenic to Bacillus subtilis QST713.

In certain embodiments, the swrA⁻ cells comprise at least about 3.5% of the total cells in the composition and at least 70% of the swrA⁻ cells are spores. The present invention further provides such compositions wherein the swrA⁻ cells comprise at least 10% of the total cells in the composition, or comprise at least 50% of the total cells in the composition, or comprise 100% of the total cells in the composition. The present invention further provides such compositions wherein at least about 80%, at least about 85%, or at least about 90% of the swrA⁻ cells and/or of the total cells in the composition are spores.

In some embodiments, the percentage of swrA⁻ cells in the total cells in the compositions and methods of the present invention will be at least 3.5%, or at least 3.6%, or at least 3.7%, or at least 3.8%, or at least 3.9%, or at least 4%, or at least 5%, or at least 6%, or at least 7%, or at least 8%, or at least 9%, or at least 10%, or at least 15%, or at least 20%, or at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 98%, or at least 99%, or be 100%. In some embodiments of the present invention, all of the cells present in a particular composition or used in a particular method are all swrA⁻ cells (i.e., 100% swrA⁻ cells).

In some embodiments, the percentage of swrA⁻ cells in the total cells in the composition and methods of the present invention will be about 3.5% to about 99.9%. In another embodiment, the percentage will be about 5% to about 99%. In another embodiment, the percentage will be about 10% to about 99%.

In some embodiments, the number of colony forming units (“cfu”) per gram (“g”) of swrA⁻ cells in the compositions and methods of the present invention will be at least 1×10⁷ cfu/g or at least 1×10⁸ cfu/g or at least 1×10⁹ cfu/g or at least 2×10⁹ cfu/g, or at least 3×10⁹ cfu/g or at least 4×10⁹ cfu/g or at least 5×10⁹ cfu//g or at least 6×10⁹ cfu/g or at least 7×10⁹ cfu/g, or at least 8×10¹⁰ cfu/g, or at least 8.5×10¹⁰ cfu/g, or at least 9×10¹⁰ cfu/g, or at least 9.5×10¹⁰ cfu/g, or at least 1×10¹¹ cfu/g, or at least 2×10¹¹ cfu/g, or at least 3×10¹¹ cfu/g, or at least 4×10¹¹ cfu/g, or at least 5×10¹¹ cfu/g, or at least 6×10¹¹ cfu/g, or at least 7×10¹¹ cfu/g, or at least 8×10¹¹ cfu/g, or at least 9×10¹¹ cfu/g, or at least 1×10¹² cfu/g, or at least 1×10¹³ cfu/g, or at least 1×10¹⁴ cfu/g.

In other embodiments the total amount of swrA⁻ cells in the compositions and methods of the present invention is based on the relative or actual dry weight basis of the swrA⁻ cells in the total compositions. In some embodiments the total amount of swrA⁻ cells in the compositions and methods of the present invention is based on the cfu/g of the swrA⁻ cells in the compositions.

In some embodiments the abiotic stress resistance that is increased by treating a plant with a composition comprising Bacillus subtilis, Bacillus pumilus or a mutant thereof is nutrient deficiency. One example of nutrient deficiency is deficiency of a soil nutrient such as potassium, phosphate or iron.

The term “abiotic stress” is used herein in its regular meaning as the negative impact of non-living factors on living organisms in a specific environment and thus with reference to plants means the negative impact of non-living factors on a plant in a specific environment. The non-living factor (variable) influences the environment beyond its normal range of variation to adversely affect the performance of a plant population or the individual physiology of a plant in a significant way. Whereas biotic stress includes living disturbances such as fungi or harmful insects, abiotic stress factors can either be naturally occurring or man-made and include temperature, drying soil, osmotic stress, drought, salt or nutrient deficiency all of which may cause harm to the plants in the area affected (cf. for example, Table 2 of Bianco Carmen and Defez Roberto (2011). Soil Bacteria Support and Protect Plants Against Abiotic Stresses, Abiotic Stress in Plants—Mechanisms and Adaptations, Prof. Arun Shanker (Ed.), ISBN: 978-953-307-394-1, InTech, Available from: http://www.intechopen.com/books/abiotic-stress-in-plants-mechanisms-andadaptations/soil-bacteria-support-and-protect-plants-against-abiotic- stresses. In this context, in some embodiments, heavy metal toxicity is excluded from the stress factors causing abiotic stress.

The term “nutrient deficiency” as used herein refers to nutrient deficiency that results in nutrient starvation of a plant when grown under nutrient deficient conditions. Thus, the term “increasing the resistance to nutrient deficiency” refers to the ability of the bacteria contemplated herein (or compositions containing these bacteria) to provide nutrients to the plant to reduce or eliminate the lack of a nutrient, thereby reducing or eliminating abiotic stress (cf. Lunde et al, Climate Change: Global Risks, Challenges and Decisions, IOP Conf. Series: Earth and Environmental Science 6 (2009) 372029, doi:10.1088/1755-1307/6/7/372029, IOP Publishing). The increased resistance to stress caused by nutrient deficiency is caused by the ability of bacteria to solubilize soil nutrients such as potassium, phosphate or iron, making them available for plant uptake. In the case of improved iron availability, the improvement in its availability is believed to be caused by the production of siderophore by the bacteria used in the invention which in turn can complex iron and thus make it available for uptake by the plants. Such availability for plant uptake is also referred to herein as “bioavailability.” According to the present invention, “improved bioavailability” means that uptake of one or more soil nutrients is increased or improved by a measurable or noticeable amount over the same nutrient uptake by a plant produced under the same conditions, but without the application of the composition of the present invention. Uptake may be measured by harvesting and analyzing plant tissue. According to the present invention, it is preferred that the bioavailability be increased by at least 0.5%, or by at least 1%, or by at least 2%, or by at least 4%, or by at least 5%, or by at least 10% when compared to appropriate controls.

In some embodiments, the strains and compositions used in the present invention are applied prior to planting and may be referred to as soil inoculants. Pre-planting application improves bioavailability of soil nutrients and/or enhances yield and/or growth and/or vigor of plants that are planted in pre-treated soil. In specific embodiments, the strain and compositions are applied to soil or potting media at least about one day prior to planting, or at least about two days prior to planting, or at least about three days prior to planting, or at least about four days prior to planting, or at least about five days prior to planting, or at least about six days prior to planting, or at least about seven days prior to planting, or at least about eight days prior to planting, or at least about nine days prior to planting, or at least about ten days prior to planting, or at least about 11 days prior to planting, or at least about 12 days prior to planting, or at least about 13 days prior to planting, or at least about 14 days prior to planting, or at least about 2.5 weeks prior to planting, or at least about three weeks prior to planting.

In some embodiments, the strains and compositions used in the present invention enhance soil nutrition. The term “soil nutrition” as used herein refers to the condition of soil in terms of the levels of available plant nutrients it contains. By enhancing soil nutrition, the present invention increases the availability of these plant nutrients. Plant nutrients include nitrogen (N), phosphorus (P), potassium (K), calcium (Ca), sulphur (S), magnesium (Mg), silicon (Si), boron (B), chlorine (Cl), manganese (Mn), iron (Fe), zinc (Zn), copper (Cu), molybdenum (Mo), nickel (Ni), selenium (Se) and sodium (Na).

Organic materials when returned to the soil provide soil nutrition and organic carbon. This organic carbon improves the health of the soil and the crop plants. To utilize the plant nutrients present in the organic materials biodegradation is necessary to reduce them into simpler compounds. In one embodiment, the process of biodegradation is facilitated by the strains and compositions of the present invention when applied to the soil. This process of biodegradation of the organic materials and enrichment of organic carbon in the soil also provides the soil with water retaining stability.

In one embodiment, the strains and compositions of the present invention facilitate biodegradation of organic materials with hydrolytic enzymes. The hydrolytic enzymes may be proteinases, cellulases, or xylanases, which catalyze the hydrolysis of proteins, cellulose, and xylan, respectively. In some embodiments, the cellulase is an endoglucanase and the xylanase is an endoxylanase. Endoglucanases and endoxylanases cleave internal bonds within cellulose and xylan polysaccharides, respectively, while exoglucanases and exoxylanses cleave bonds near the exposed ends (e.g., 2 to 4 units from the end) of the polysaccharides.

In certain embodiments, the method of enhancing soil nutrition further comprises applying organic material to the soil. Organic material may be in the form of compost, animal waste, or any other source of organic carbon.

In some other embodiments, the abiotic stress resistance that is increased by treating a plant with a composition comprising Bacillus subtilis, Bacillus pumilus or a mutant thereof is salt stress resistance. Examples of salt stress are salt tolerance or drought resistance.

The term “salt tolerance” is used herein its regular meaning to refer to the resistance of plants to salt concentration. Thus, by “increasing salt tolerance resistance of a plant” is meant that the ability of the plant to withstand or tolerate a salt concentration (in its environment that as in soil or in water) is increased/improved when the plant is exposed to salt concentration that are higher than the salt concentration which are usually physiologically acceptable to the plant.

The term “drought tolerance” is also herein used in its regular meaning to be the ability of a plant to maintain favorable water balance and turgidity even exposed to drought conditions thereby avoiding stress and its consequences. Thus, by “increasing drought resistance” of a plant is meant that the ability of the plant to maintain favorable water balance and turgidity is increased/improved than when the plant is exposed to drought conditions in which the plant does not receive the amount of water regularly needed to maintain its water balance and turgidity.

The term “salt stress” refers to the exposure of a plant to an ionic strength that deviates from the optimal ionic strength for the respective plant. Typically the ionic strength deviates from optimal ionic strength in that it is about 1.2 times or more higher or lower than the optimal ionic strength for the respective plant. In some embodiments the ionic strength deviates from optimal ionic strength for the respective plant in that it is about 1.5 times or more higher or lower than the optimal ionic strength for the respective plant. In some embodiments the ionic strength deviates from optimal ionic strength by a factor of 2, including a factor of 2.5. In some embodiments the ionic strength is about three times or more higher or lower than the optimal ionic strength for the respective plant. In some embodiments the ionic strength deviates from optimal ionic strength by a factor of 3.5, including a factor of 4. In some embodiments the ionic strength is about five times or more higher or lower than the optimal ionic strength for the respective plant. Salt stress may be caused by concentration of one or more of NaCl, KCl, LiCl, MgCl₂, and CaCl₂, which deviate from optimal concentrations of the respective salt by a factor of about 1.5 or more.

In some embodiments the concentration of NaCl, KCl, LiCl, MgCl₂, and/or CaCl₂ deviates from the optimal concentration of the respective plant for the respective salt by a factor of about 1.5 times or more. In some embodiments the concentration of NaCl, KCl, LiCl, MgCl₂, and/or CaCl₂ deviates from the optimal concentration of the respective plant for the respective salt by a factor of about twice or more, including a factor of 2.5 or a factor of 3. In some embodiments the concentration of NaCl, KCl, LiCl, MgCl₂, and/or CaCl₂ deviates from the optimal concentration of the respective plant for the respective salt by a factor of about 4 times or more.

In some embodiments the optimal ionic strength is defined by a known range of ionic strength, in which a given plant shows optimal vigor, growth, biomass production or any other suitable parameter as illustrated below. Likewise the optimal concentration of one or more of NaCl, KCl, LiCl, MgCl₂ and CaCl₂ may be known to be defined by a certain range, in which a given plant shows optimal vigor, growth, biomass production or any other suitable parameter as illustrated below. Salt stress may in such an embodiment be defined by an ionic strength that exceeds the upper limit of such a range or that falls below the lower limit of a respective range by a factor of about 1.2 times or more. The above said with regard to an optimal ionic strength or salt concentration otherwise applies mutatis mutandis. Salt resistance may in some embodiments be verified by exposing a plant of interest to water with an elevated salt concentration (see also the Example Section). The salt concentration of water that irrigates soil can usefully be expressed as parts per million of the dissolved salts w/w in the water. Fresh water typically has less than 1,000 ppm salt; slightly saline water typically has from 1,000 ppm to 3,000 ppm; moderately saline water typically has from 3,000 ppm to 10,000 ppm; highly saline water typically has from 10,000 ppm to 35,000 ppm; while ocean water typically has 35,000 ppm of salt.

An increased salt stress resistance (i.e., salt tolerance or drought resistance) of a plant may be analysed by any desired method available in the art. Typically a feature of the plant of interest is compared to a reference. Such a reference may be a corresponding plant kept under the same or comparable conditions with the exception that the plant is not being exposed to a composition that includes Bacillus subtilis or Bacillus pumilus. In some embodiments a further reference may be used to account for the effect of salt stress. Such a further reference may be a plant that corresponds to the plant of interest in that it is kept under the same or comparable conditions with the exception that the plant is not being exposed to conditions that induce salt stress. Thus a plant serving as such a further reference is typically kept at conditions where the plant is exposed to salt levels that are known to be well tolerated by the respective plant species.

Salt stress typically manifests itself as osmotic stress, resulting in the disruption of homeostasis and ion distribution in cells of a plant. Such salinity or drought stress may cause denaturing of functional and structural proteins. As a consequence, cellular stress signaling pathways and cellular stress responses can be activated, such as the production of stress proteins, up-regulation of anti-oxidants, accumulation of compatible solutes and growth arrest.

An example of an indicator of salt stress resistance or other abiotic stress resistance (such as nutrient deficiency resistance) of a plant is the growth rate of the plant. The growth rate of the plant may for instance be assessed by monitoring the plant height, the root length or the shoot length of the plant over a period of time. A further example of an indicator of abiotic stress resistance of a plant is the development of the plant. In this regard it may for example be assessed how long it takes a plant to reach the various stages of development. In general terms in this regard, an example of an indicator of abiotic stress resistance of a plant is the plant vigor. The plant vigor becomes manifest in several aspects, too, some of which are visual appearance, e.g., leaf color, fruit color and aspect, amount of dead basal leaves and/or extent of leaf blades, plant weight, plant height, extent of plant verse (lodging), number, strongness and productivity of tillers, panicles' length, extent of root system, strongness of roots, extent of nodulation, in particular of rhizobial nodulation, point of time of germination, emergence, flowering, grain maturity and/or senescence, protein content, sugar content, thousand kernel weight, percentage germination, percentage emergence, seedling growth, seedling height, root length or root and shoot biomass, to name a few examples (see also the Example Section in which the size and weight of roots or shouts were used to assess the salt stress resistance of rice plants). The term “biomass” as used herein refers to the total weight of a plant. Within the definition of biomass, a distinction may be made between the biomass of one or more parts of a plant, which may include any one or more of the following: aboveground parts such as but not limited to shoot biomass, seed biomass and leaf biomass; aboveground harvestable parts such as but not limited to shoot biomass, seed biomass, and leaf biomass; parts below ground, such as but not limited to root biomass; vegetative biomass such as root biomass or shoot biomass; reproductive organs; and propagules such as seed.

Another example of an indicator of abiotic stress resistance of a plant is the crop yield. “Crop” and “fruit” are to be understood as any plant product which is further utilized after harvesting, e.g., fruits in the proper sense, vegetables, nuts, grains, seeds, wood (e.g., in the case of silviculture plants) or flowers (e.g., in the case of gardening plants, ornamentals). On a general basis crop and fruit may be anything of economic value that is produced by the plant. Yet a further example of an indicator of abiotic stress resistance of a plant is the plant's tolerance or resistance to biotic stress factors. In some embodiments seedling survival can serve as a further example of an indicator of abiotic stress resistance of a plant. Any such indicator of abiotic stress resistance of a plant may be analyzed where desired, whether alone or several indicators in combination with each other.

In this regard, an “increased yield” of a plant, such as of an agricultural, silvicultural and/or ornamental plant means that the yield of a product of the respective plant is increased by a measurable amount over the yield of the same product of the plant produced under the same exposure to abiotic stress, including drought or nutrient deficiency, but without the application of the composition of the invention. In some embodiments the yield of a plant with enhanced abiotic stress resistance is increased by about 0.5% or more, when compared to an untreated corresponding plant under similar or the same conditions of abiotic stress. In some embodiments the yield of a plant with enhanced abiotic stress resistance is increased by at least about 1% under conditions of abiotic stress. In some embodiments the yield is increased by at least about 2%, such as by at least about 4% under conditions of abiotic stress. In some embodiments the yield is increased by at least about 5% under conditions of abiotic stress. In some embodiments the yield is increased by at least about 10% when compared to a suitable control under conditions of abiotic stress.

The drought resistance of a plant of interest (and thus the increase in its drought resistance relative to a control plant cultivated under identical conditions) can also be determined by treating the plant with a composition of Bacillus subtilis or Bacillus pumilus for a suitable period of time and then stopping or reducing watering and then determining which plant, the plant treated with a composition of Bacillus subtilis or Bacillus pumilus or the control, collapses last. Alternatively, drought resistance can be determined by cycling the plants through repeated cycles of water stress (i.e., not to irrigate the plants) and adequate water and assess which plant collapse last.

As explained above, in a method of the present invention the composition that includes Bacillus subtilis and/or Bacillus pumilus can be applied to a wide variety of agricultural and/or horticultural crops, including those grown for seed, produce, landscaping and those grown for seed production. Representative plants to which the composition can be applied include but are not limited to the following: brassica, bulb vegetables, cereal grains, citrus, cotton, curcurbits, fruiting vegetables, leafy vegetables, legumes, oil seed crops, peanut, pome fruit, root vegetables, tuber vegetables, corm vegetables, stone fruit, tobacco, strawberry and other berries, and various ornamentals.

The composition used in the context of the invention may be used and/or provided in any form that maintains the Bacillus subtilis and/or Bacillus pumilus, respectively, in an at least essentially viable form. The composition may be applied to the surface of a plant, to the surface of a portion of a plant, to a fruit, to the vicinity of a plant, to the vicinity of a fruit, to an area encompassing the plant or the fruit or to an area encompassing the plant part.

The composition may be administered as a foliar spray, as a seed/root/tuber/rhizome/bulb/corm/slip treatment and/or as a soil treatment. The composition may be applied to the seeds/root/tubers/rhizomes/bulbs/corms/slips before planting, during planting or after planting. When used as a seed treatment, the compositions of the present invention are applied at a rate of about 1×10² to about 1×10¹⁰ colony forming units (“cfu”)/seed, depending on the size of the seed. In some embodiments, the compositions of the present invention are applied at a rate of about 1×10² to about 1×10⁹ cfu/seed, depending on the size of the seed. In some embodiments, the compositions of the present invention are applied at a rate of about 1×10² to about 1×10⁸ cfu/seed, depending on the size of the seed. In some embodiments, the compositions of the present invention are applied at a rate of about 1×10² to about 1×10⁷ cfu/seed, depending on the size of the seed. In some embodiments, the application rate is about 1×10³ to about 1×10⁸ cfu per seed, depending on the size of the seed. In some embodiments, the application rate is about 1×10³ to about 1×10⁷ cfu per seed, depending on the size of the seed. In some embodiments, the application rate is about 1×10³ to about 1×10⁶ cfu per seed, depending on the size of the seed. In some embodiments, the application rate is about 1×10⁴ to about 1×10⁷ cfu per seed, depending on the size of the seed. When used as a soil treatment, the compositions of the present invention can be applied as a soil surface drench, shanked-in, injected and/or applied in-furrow or by mixture with irrigation water. The rate of application for drench soil treatments, which may be applied at planting, during or after seeding, or after transplanting and at any stage of plant growth, is about 4×10⁷ to about 8×10¹⁴ cfu per acre or about 4×10⁹ to about 8×10¹³ cfu per acre or about 4×10¹¹ to about 8×10 ¹² cfu per acre or about 2×10¹² to about 6×10¹³ cfu per acre or about 2×10¹² to about 3×10¹³ cfu per acre. In some embodiments, the rate of application is about 1×10¹² to about 6×10¹² cfu per acre or about 1×10¹³ to about 6×10¹³ cfu per acre. In some embodiments, the rate of application for drench soil treatments, which may be applied at planting, during or after seeding, or after transplanting and at any stage of plant growth, is typically about 4×10¹¹ to about 8×10¹² cfu per acre. In other embodiments, the rate of application is about 1×10¹² to about 6×10¹² cfu per acre. In still other embodiments, the rate of application is about 6×10¹² to about 8×10¹² cfu per acre. In other embodiments, the rate of application is at least about 1×10⁸ cfu per acre, at least about 1×10⁹ cfu per acre, at least about 1×10¹⁰ cfu per acre, at least about 1×10¹¹ cfu per acre, at least about 1×10¹² cfu per acre, or at least about 1×10¹³ cfu per acre. The rate of application for in-furrow treatments, applied at planting, is about 2.5×10¹⁰ to about 5×10¹¹ cfu per 1000 row feet. In some embodiments, the rate of application is about 6×10¹⁰ to about 4×10¹¹ cfu per 1000 row feet. In other embodiments, the rate of application is about 3.5×10¹¹ cfu per 1000 row feet to about 5×10¹¹ cfu per 1000 row feet. In still other embodiments, the rate of application for in-furrow treatements, applied at planting, is at least about 1×10⁹ cfu per 1000 row feet, at least about 1×10¹⁰ cfu per 1000 row feet, at least about 1×10¹¹ cfu per 1000 row feet, or at least about 1×10¹² cfu per 1000 row feet.

The composition may also be prepared for application as a fumigant for both outdoor as well as indoor application, for example in closed environments, such as greenhouses, animal barns or sheds, human domiciles, and other buildings. Persons of skill in the art will appreciate the various methods for preparing such fumigants, for example, as fogging concentrates and smoke generators. A fogging concentrate is generally a liquid formulation for application through a fogging machine to create a fine mist that can be distributed throughout a closed and/or open environment. Such fogging concentrates can be prepared using known techniques to enable application through a fogging machine. Smoke generators, which are generally a powder formulation which is burned to create a smoke fumigant. Such smoke generators can also be prepared using known techniques.

In a method according to the invention the composition may be applied in a number of different ways. For small scale application backpack tanks, hand-held wands, spray bottles, or aerosol cans can be utilized. For somewhat larger scale application, tractor drawn rigs with booms, tractor drawn mist blowers, airplanes or helicopters equipped for spraying, or fogging sprayers can all be utilized. Small scale application of solid formulations can be accomplished in a number of different ways, examples of which are: shaking product directly from the container or gravity-application by human powered fertilizer spreader. Large scale application of solid formulations can be accomplished by gravity fed tractor drawn applicators, or similar devices.

In some embodiments the composition that contains Bacillus subtilis and/or Bacillus pumilus can be applied before, during and/or shortly after the plants are transplanted from one location to another, such as from a greenhouse or hotbed to the field. In another example, the compositions can be applied shortly after seedlings emerge from the soil or other growth media (e.g., vermiculite). In yet another example, the compositions can be applied at any time to plants grown hydroponically. Hence, according to the methods of the present invention the compositions can be applied at any desirable time during the life cycle of a plant. In some other embodiments, the compositions of the present invention are applied to a plant and/or plant part twice, during any desired development stages, at an interval of about 1 hour, about 5 hours, about 10 hours, about 24 hours, about two days, about 3 days, about 4 days, about 5 days, about 1 week, about 10 days, about two weeks, about three weeks, about 1 month or more. In some embodiments, the compositions of the present invention are applied to a plant and/or plant part for more than two times, for example, 3 times, 4 times, 5 times, 6 times, 7 times, 8 times, 9 times, 10 times, or more, during any desired development stages, at an interval of about 1 hour, about 5 hours, about 10 hours, about 24 hours, about two days, about 3 days, about 4 days, about 5 days, about 1 week, about 10 days, about two weeks, about three weeks, about 1 month or more. The intervals between each application can vary if it is desired.

The present invention further provides any of the compositions of the present invention further comprising at least one other active ingredient or agent in addition to the swrA⁻ cells. Such other active ingredients or agents can be a chemical or another strain of bacteria. Examples of suitable active ingredients or agents include but are not limited to an herbicide, a fungicide, a bactericide, an insecticide, a nematicide, a miticide, a plant growth regulator, a plant growth stimulant, a fertilizer, and combinations thereof.

The present invention further provides any of the spore-forming bacteria such as Bacillus subtilis or compositions of the present invention further comprising a formulation inert or other formulation ingredient, such as polysaccharides (starches, maltodextrins, methylcelluloses, proteins, such as whey protein, peptides, gums), sugars (lactose, trehalose, sucrose), lipids (lecithin, vegetable oils, mineral oils), salts (sodium chloride, calcium carbonate, sodium citrate), and silicates (clays, amorphous silica, fumed/precipitated silicas, silicate salts). In some embodiments, such as those in which the compositions are applied to soil, the compositions of the present invention comprise a carrier, such as water or a mineral or organic material such as peat that facilitates incorporation of the compositions into the soil. In some embodiments, such as those in which the composition is used for seed treatment or as a root dip, the carrier is a binder or sticker that facilitates adherence of the composition to the seed or root. In another embodiment in which the compositions are used as a seed treatment the formulation ingredient is a colorant. In other compositions, the formulation ingredient is a preservative.

Compositions of the present invention may include formulation inerts added to compositions comprising cells, cell-free preparations or metabolites to improve efficacy, stability, and usability and/or to facilitate processing, packaging and end-use application. Such formulation inerts and ingredients may include carriers, stabilization agents, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the carrier is a binder or adhesive that facilitates adherence of the composition to a plant part, such as a seed or root. See, for example, Taylor, A. G., et al., “Concepts and Technologies of Selected Seed Treatments” Annu. Rev. Phytopathol. 28: 321-339 (1990). The stabilization agents may include anti-caking agents, anti-oxidation agents, desiccants, protectants or preservatives. The nutrients may include carbon, nitrogen, and phosphors sources such as sugars, polysaccharides, oil, proteins, amino acids, fatty acids and phosphates. The physical property modifiers may include bulking agents, wetting agents, thickeners, pH modifiers, rheology modifiers, dispersants, adjuvants, surfactants, antifreeze agents or colorants. In some embodiments, the composition comprising cells, cell-free preparation or metabolites produced by fermentation can be used directly with or without water as the diluent without any other formulation preparation. In some embodiments, the formulation inerts are added after concentrating fermentation broth and during and/or after drying.

The listing or discussion of a previously published document in this specification should not necessarily be taken as an acknowledgement that the document is part of the state of the art or is common general knowledge.

The invention illustratively described herein may suitably be practiced in the absence of any element or elements, limitation or limitations, not specifically disclosed herein. Thus, for example, the terms “comprising”, “including,” containing“, etc. shall be read expansively and without limitation. Singular forms such as “a”, “an” or “the” include plural references unless the context clearly indicates otherwise. Unless otherwise indicated, the term “at least” preceding a series of elements is to be understood to refer to every element in the series. The terms “at least one” and “at least one of” include for example, one, two, three, four, or five or more elements. Slight variations above and below the stated ranges can be used to achieve substantially the same results as values within the ranges. Also, unless indicated otherwise, the disclosure of the ranges is intended as a continuous range including every value between the minimum and maximum values.

Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by exemplary embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the appending claims. In addition, where features or aspects of the invention are described in terms of Markush groups, those skilled in the art will recognize that the invention is also thereby described in terms of any individual member or subgroup of members of the Markush group.

In order that the invention may be readily understood and put into practical effect, particular embodiments will now be described by way of the following non-limiting examples, which are given for purely illustrative purposes.

### EXAMPLES

### Example 1

### Increase in Salt Stress Resistance by Bacillus subtilis

A first study was conducted to analyze whether plant growth promotion is visible in rice seedlings drenched with SERENADE° when irrigated with salt.

### Procedure:

Three rice seeds, variety RM401, were sown into 2.5″ pots filled with Profile Greens Grade. Each seed received (as exemplary fermentation product/composition used herein) 2 mL of commercial SERENADE® at 64 oz/acre (11.2% out of 100 mL total volume), or water. The pots were placed in no-hole flats by drench treatment group and grown in a greenhouse. The plants were irrigated with 20-20-20 fertilizer at 100 ppm N for the duration of the experiment and irrigation levels were maintained at approximately half the height of the pots. Fourteen days after seeding, ten pots of each drench treatment group (H₂O, or SERENADE° 64oz/acre) received salt concentrations of 60 mM salt with irrigation. The water in the flats was replaced twice a week and the plants were rated 14 days after salt treatments began. The plants were harvested and allowed to dry. Root and shoot weights were collected.

### Results:

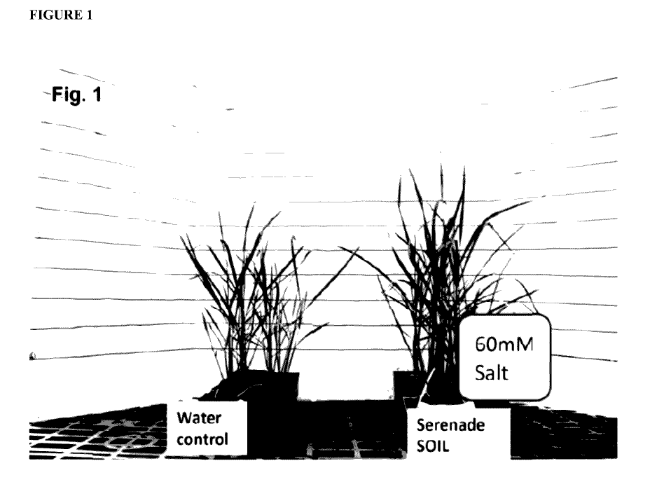

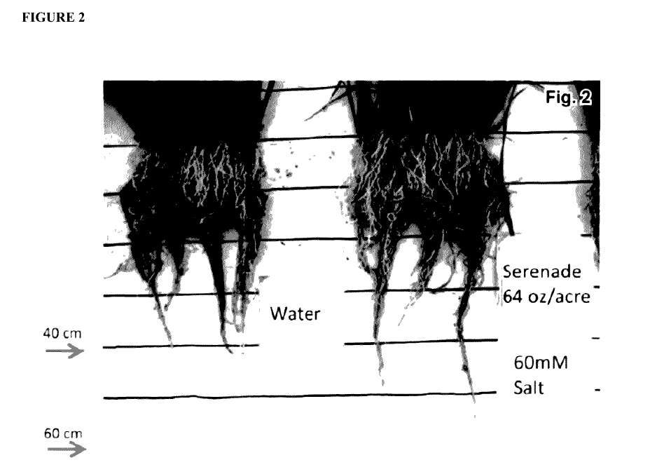

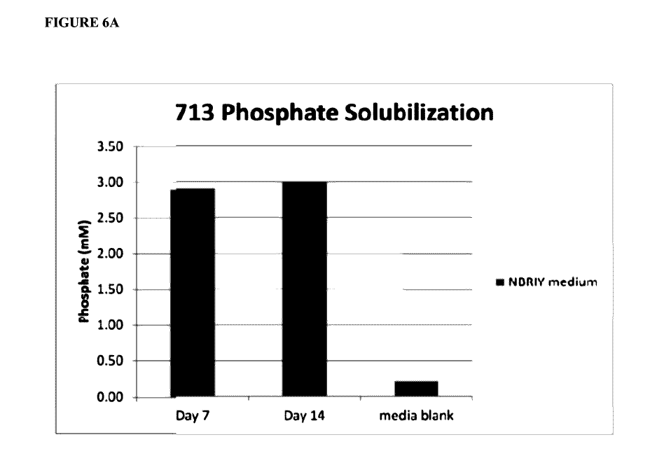

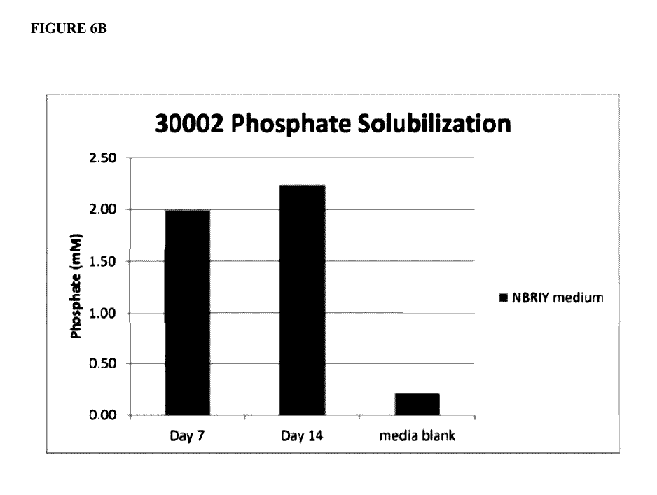

Rice plants treated with SERENADE SOIL® and irrigated with salt at 60 mM for 14 days looked taller than plants treated with water under salt stress (FIG. 1). The roots of rice plants with SERENADE SOIL® and irrigated with salt at 60 mM for 14 days looked longer than plants treated with water under salt stress (FIG. 2). In a separate experiment conducted in the same way as described above, roots and shoot weights of plants treated with SERENADE ASO® and irrigated with salt at 60 mM for 14 days were significant higher than weights of plants treated with water. See FIG. 5. Thus, this result shows that a composition/fermentation product of B. subtilis QST713 increases salt stress resistance (salt stress tolerance) of plants.

### Example 2

### Increase in Salt Stress Resistance by Bacillus pumilus

A second study was conducted to analyze whether plant growth promotion is visible in rice seedlings drenched with SONATA® when irrigated with salt. In this study, the efficacy of the treatment with SONATA® was also compared to the treatment of the plants with SERENADE®.

### Procedure:

Three rice seeds, variety RM401, were sown into 2.5″ pots filled with Profile Greens Grade. Each seed received (as exemplary fermentation product/composition used herein) 2 mL of commercial SONATA® or SERENADE® at 64 oz/acre (11.2% out of 100 mL total volume normalized by cfus/plant), or water. The pots were placed in no-hole flats by drench treatment group and grown in a greenhouse. The plants were irrigated with 20-20-20 fertilizer at 100 ppm N for the duration of the experiment and irrigation levels were maintained at approximately half the height of the pots. Fourteen days after seeding, ten pots of each drench treatment group (H₂O, or SERENADE® 64 oz/acre) received salt concentrations of 60 mM salt with irrigation. The water in the flats was replaced twice a week and the plants were rated 14 days after salt treatments began. The plants were harvested and allowed to dry. Root and shoot weights were collected.

### Results:

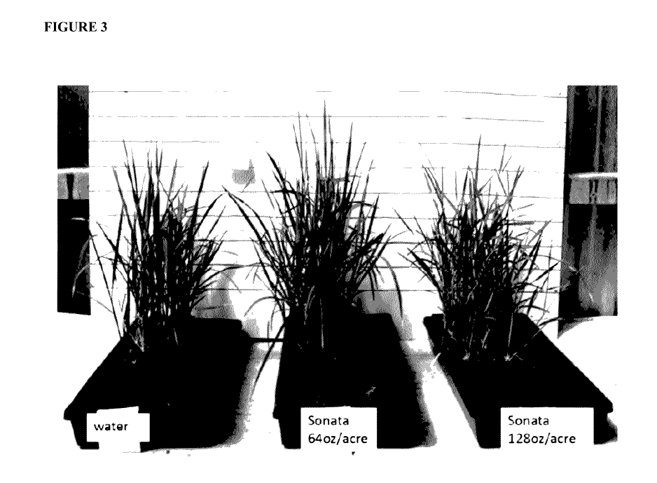

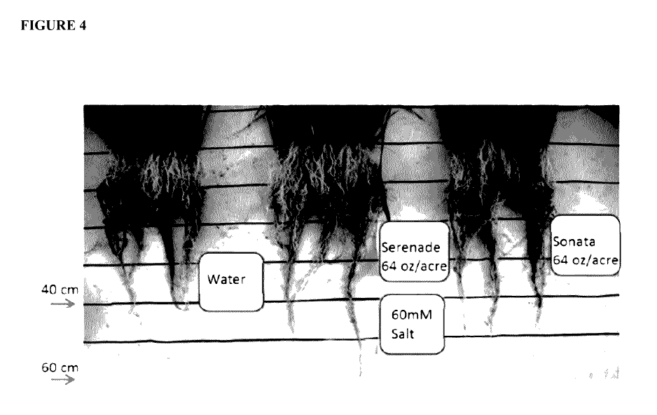

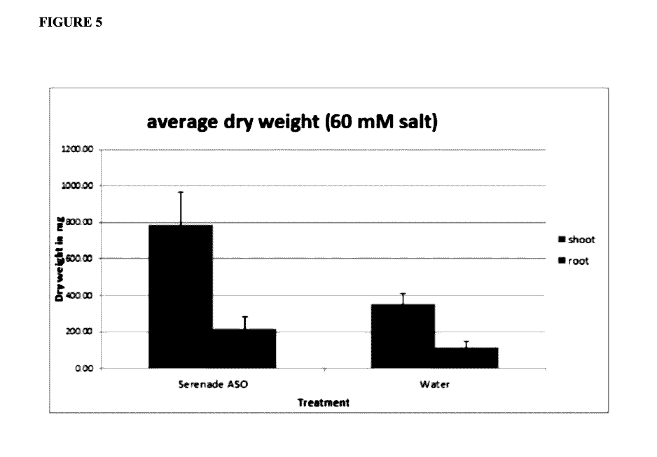

Rice plants treated with SONATA® and irrigated with salt at 60 mM for 14 days looked taller than plants treated with water under salt stress (FIG. 3). The roots of rice plants treated with SONATA® and SERENADE SOIL®, respectively and irrigated with salt at 60 mM for 14 days looked longer than plants treated with water under salt stress (FIG. 4). FIG. 5 shows the root and shoot dry weights in mg of plants treated with SERENADE ASO® and plants treated with water. Both shoot and root dry weights are significantly higher for the SERENADE ASO®-treated plants than the water-treated plants. Thus, this result shows that a composition/fermentation product of B. pumilis QST2808 increases salt stress resistance (salt stress tolerance) of plants.

### Example 3

### Increase in Drought Stress Resistance

Salt tolerance is generally accepted to mimic drought tolerance, so that it can be concluded that plants showing salt tolerance will also be drought tolerant. Thus, the experiments described above also indicate that B. subtilis QST713 and B. pumilis QST2808 also increases drought resistance of plants.

Drought resistance can also be determined as follows.

Plants such as rice seeds, variety RM401, are sown into 2.5″ pots filled with Profile Greens Grade. Each seed receives 2 mL of commercial SONATA® or SERENADE® at 64 oz/acre (11.2% out of 100 mL total volume), or water. The pots are placed in no-hole flats by drench treatment group and grown in a greenhouse. The plants are irrigated with 20-20-20 fertilizer at 100 ppm N for the duration of the experiment and irrigation levels are maintained at approximately half the height of the pots. Fourteen days after seeding, ten pots of each drench treatment group (H₂O, or SERENADE® 64 oz/acre) watering is stopped or reduced and it will be determined which plant collapses last. Based on the results above, it is expected that the plants treated with SONATA® or SERENADE® will collapse after the plants that only received water.

Another typical protocol that can be used to determine drought tolerance is to cycle the plants through repeated cycles of water stress (i.e., not to irrigate the plants) and adequate water and assess which plants collapse last. For example, the water is stopped until the SONATA® and SERENADE®-treated plants show signs of distress at which point the plants are watered again. An assessment will be made as to which plants collapse last or look healthier at the end of the experiment. Based on the results above, it is also expected that the plants treated with SONATA® or SERENADE® will collapse after the plants that only received water or look healthier at the end of the experiment when compared to plants only treated with water.

### Example 4

### Assays to Determine Nutrient Solubilization Properties of Phosphate Solubilization by Bacillus subtilis

Fresh cultures of bacterial strain (AQ30002 and AQ713) were grown in shaker flask containing NBRIY medium (Glucose 10 g/L, Ca₃(PO₄)₂ 5 g/L (NH₄)₂SO₄ 0.1 g/L, NaCl_{0.2} g/L, MgSO₄×7 H₂O 0.25 g/L, KCl 0.2 g/L, MgCl₂×6 H₂O 5 g/L, FeSO₄×7 H₂O 0.002 g/L. The flasks were incubated at 30° C. with shaking at 200 rpm for up to 14 days. The concentrations of soluble potassium in the supernatant of culture broth were measured after 7 and 14 days by a colorimetric assay using spectrophotometer at 660 nm, using blank medium as control. As can be seen from FIG. 6A and FIG. 6B both strains provide for significant higher levels of soluble phosphate in NBRIY medium compared to the blank medium (FIG. 6A phosphate solubilisation by AQ713, FIG. 6B phosphate solubilisation by AQ30002).

### Example 5

### Assays to Determine Nutrient Solubilization Properties of Bacillus subtilis A—Siderophore Production for Improving Iron Availability

Fresh cultures of bacterial strain (AQ30002 and AQ713) were inoculated on chrome azurol S (CAS) agar plates using the overlay CAS agar method according to Pérez-Miranda et al. O-CAS, a fast and universal method for siderophore detection. J. Microbiol. Methods 70:127-131, 2007. The plates were incubated at 30° C. for up to 7 days. Plates were visually examined for color change from blue to orange, which indicated siderophore production. AQ30002 and AQ713 colonies caused a color change indicating that both strains have utility as soil inoculants to provide sufficient siderophore production to provide improved iron availability.

### Example 6

### Assays to Determine Endoglucanase, Endoxylanase, and Proteinase Activities to Enhance Soil Nutritional Levels

Endoglucanase, endoxylanase, and proteolytic activity were measured using nutrient agar supplemented with 1% carboxymethyl cellulose sodium (CMC-Na), 1% xylan, and 1% AZO-casein, respectively. AQ30002 and AQ713 bacterial strains were first grown on nutrient agar plates from Hardy Diagnostics incubated overnight at 30° C. A single colony was then transferred onto the middle of the plates supplemented with substrate (CMC-Na, xylan, AZO-casein). Plates were then incubated at 30° C. for 2-7 days. If at the end of the incubation period a clearing zone was visualized then enzymatic activity was recorded as positive.

Incubation of the AQ30002 and AQ713 colonies on the plates supplemented with substrate produced a clearing zone with each substrate. Endoglucanase and endoxylanase hydrolyze cellulose and xylan, respectively, both of which are polysaccharides present in plant cell walls. These hydrolytic activities together with the proteinase activity allow AQ713 and AQ30002 to facilitate the conversion of the organic material present in the soil into nutrients that can be utilized by growing plants.

Plant roots also extrude many organic materials onto the root surface. Without wishing to be bound to any theory, root colonizers like AQ713 and AQ30002 can use the extrudates as an energy source to grow along the roots and, at the same time, release minerals from the organic materials through enzymatic action for the plant to uptake.

What is claimed is:

1. A method of increasing abiotic stress resistance of a plant, the method comprising applying to the plant, to a part of the plant and/or to an area around the plant or plant part a composition comprising a fermentation product of Bacillus subtilis QST713, wherein the composition is applied at a rate of about 4×10⁷ to about 8×10¹⁴ cfu per acre and wherein the plant is exposed to abiotic stress and the vigor of the plant is enhanced or the yield of the plant is increased compared to a plant exposed to abiotic stress to which the composition is not applied.

2. The method of claim 1, wherein the abiotic stress resistance is salt stress resistance or resistance to nutrient deficiency.

3. The method of claim 2, wherein the salt stress resistance is one of salt tolerance or drought resistance.

4. The method of claim 2, wherein resistance to nutrient deficiency is increased by nutrient solubilization or by stimulation of siderophore production of the plant in soil in an area around the plant or the plant part.

5. The method of claim 4, wherein the nutrient solubilization improves bioavailability of nutrients by at least about 5%.

6. The method of claim 4, wherein the nutrient solubilization is selected from the group consisting of potassium solubilization, phosphate solubilization or, iron solubilization caused by siderophore binding, and combinations thereof.

7. The method of claim 6, wherein the applying is preceded by identifying that the soil has low concentrations of one or more soil nutrients selected from the group consisting of potassium, phosphate, and iron.

8. The method according to claim 1, wherein the composition further comprises at least one carrier.

9. The method according to claim 1, further comprising applying at least one other active ingredient to the composition.

10. The method of claim 9, wherein the active ingredient is a chemical or another strain of bacteria.

11. The method of claim 9, wherein the active ingredient is selected from the group consisting of a plant growth regulator, a plant growth stimulant, a fertilizer, and combinations thereof.

12. The method according to claim 1, wherein the plant part is selected from the group consisting of a seed, fruit, root, corm, tuber, bulb and rhizome.

13. The method according to claim 1, wherein the method comprises applying the composition to soil.

14. The method of claim 13, wherein the composition is applied before, during or after the plant or plant part comes into contact with the soil.

15. The method of claim 14, wherein the composition is applied at least about five days prior to planting.

16. The method according to claim 1, wherein the composition is one selected from the group consisting of a liquid, a wettable powder, a granule, a flowable, and a microencapsulation.

19. The method of claim 1, wherein the plant is selected from the group consisting of a tree, a herb, a bush, a grass, a vine, a fern, moss and, a green algae, a monocotyledonous plant, and a dicotyledonous plant.

20. The method of claim 12, wherein the composition is applied to seed at a rate of at least about 1×10⁶ cfu per seed.


SEQUENCE LISTING (20 sequences)

SEQ ID NO: 1 - DNA, 351 bp, Bacillus subtilis
ttgaagagggcaagtattgtgcgtgaaaaaaaatattatgaattagtggaacaactaaaagacagaacaaaagacgtcacattttcatcaacaaaagcactaagtcttcttatgctgttcagcagatacctggtcaattacacaaatgttgaatgcgttcacgaaatcaatgaagagtgtgcgaagcattatttcacttacttaatgaaaaaccataaacgtttaggaattaatctgacggatattaagcggtccatgcttctgatcagcggcgtgatcgaggtggaggttgaccactatctgaaagatttctctctctcaaatgtaacgttgtggatgacggaagagaga

SEQ ID NO: 2 - protein, 117 aa, Bacillus subtilis
MKRASIVREKKYYELVEQLKDRTKDVTFSSTKALSLLMLFSRYLVNYTNVECVHEINEECAKHYFTYLMKNHKRLGINLTDIKRSMLLISGVIEVEVDHYLKDFSLSNVTLWMTEER

SEQ ID NO: 3 - DNA, 350 bp, Bacillus subtilis
ttgaagagggcaagtattgtgcgtgaaaaaaatattatgaattagtggaacaactaaaagacagaacaaaagacgtcacattttcatcaacaaaagcactaagtcttcttatgctgttcagcagatacctggtcaattacacaaatgttgaatgcgttcacgaaatcaatgaagagtgtgcgaagcattatttcacttacttaatgaaaaaccataaacgtttaggaattaatctgacggatattaagcggtccatgcttctgatcagcggcgtgatcgaggtggaggttgaccactatctgaaagatttctctctctcaaatgtaacgttgtggatgacggaagagaga

SEQ ID NO: 4 - DNA, 351 bp, Bacillus subtilis
ttcaagagggcaagtattgtgcgtgaaaaaaaatattatgaattagtggaacaactaaaagacagaacaaaagacgtcacattttcatcaacaaaagcactaagtcttcttatgctgttcagcagatacctggtcaattacacaaatgttgaatgcgttcacgaaatcaatgaagagtgtgcgaagcattatttcacttacttaatgaaaaaccataaacgtttaggaattaatctgacggatattaagcggtccatgcttctgatcagcggcgtgatcgaggtggaggttgaccactatctgaaagatttctctctctcaaatgtaacgttgtggatgacggaagagaga

SEQ ID NO: 5 - DNA, 351 bp, Bacillus amyloliquefaciens
ttgaagagggcaagtattgtgcgtgaaaaaaaatattatgaattagtggaacaactaaaagaccgaacaaaagacgttacattttcatcaacaaaagcactaagtcttcttatgctgttcagcagatacctggtcaattacacaaatgttgaatgtgttcacgatatcaatgaggagtgtgcaaagcattatttcacctacttaatgaaaaaccataaacgtttaggaatcaatctgacggatattaaacggtccatgcttttgatcagcggtgtaatcgaggtggaagtcgaccactatctgaaagatttctctctttcaaatgtgacgttgtggatgacggaagagaga

SEQ ID NO: 6 - DNA, 351 bp, Bacillus pumilus
ttgaaaagggcaagtattgtgagagagaaaaaatattacgagttggtagaggagcttaagagtcgtacgaaagatgtgacgttttccgctacaaaggcattaagtctgctcatgctgttaagcaggtacttggtcaattacacaacggtagaatcagtcgacgaaatagatgaagactgtgctgagatatacttcaattatttaatggataatcataagagacttggtataaacttaaccgacatcaagagatcgatgcagctgcttggcggcatactagatgtagatgtcaatcactacttaaaagatttttcactgtcgaatgtcacactttggatgaatcaggagaaa

SEQ ID NO: 7 - DNA, 351 bp, Bacillus subtilis
  misc_feature (345)..(345): n is a, c, g, or t
ttgaagagggcaagtattgtgcgtgaaaaaaaatattatgaattagtggaacaattaaaagacagaacacaagacgtaacattttcagctacaaaagcactaagtcttcttatgctgttcagcagatatttggtcaattacaccaatgtcgaatcagtaaatgacattaatgaggaatgcgccaaacattattttaactacttaatgaaaaaccataagcgattaggaattaatctgacagatataaaaaggtcgatgcatctaatcagcgggttattggatgtggatgtaaaccactatttaaaggatttttcactatcgaatgtcacgctgtggatgacgcangagaga

SEQ ID NO: 8 - DNA, 351 bp, Bacillus pumilus
ttgaaaagggcaagtattgtgagagagaaaaaatattacgagttggtagaggagcttaagagtcgtacgaaagatgtgacgttttcggctacaaaggcattaagtctactcatgctgttaagcaggtacttggtcaattacacaacggtagaatcagtcgacgagatcgatgaagactgtgctgagatatacttcaattatttaatggataatcataagagacttggtataaacttaaccgacatcaagaggtccatgcagcttctcggcggcatactagatgtagatgtgaatcactatttaaaagatttttcactgtcgaatgtcacactttggatgaatcaggagaaa

SEQ ID NO: 9 - DNA, 351 bp, Bacillus atrophaeus
ttgaagagggcaagtattgtgcgtgaaaaaaaatactatgaattagtggaacaattaaaagaccgaacacaagacgtaacattttcagctacaaaagcactaagtcttctaatgctctttagcagatatttagtcaattacacaaatgtagaatcagtgaacgatattaatgaggaatgcgccgagcattattttaattatttaatgaaaaatcataaacggttgggaatcaatctgacagacataaaacgatcaatgctcctcatcggcggtgtgttggacgtcgaggtaaaccattatttaaaggatttctctctgtctaatgtgacgctctggatgaatcaggagaga

SEQ ID NO: 10 - DNA, 351 bp, Bacillus licheniformis
ttgaaaagggcaagtattgtgagagagaaaaaatactatgaattagtggagcagttaaaagttcgatcacaagacgttacgttttccgctacaaaggcagtaggattgcttatgctgttcagcagatacctcgtgaactacacttcggtcgaaagtgtggaagatattaatgaggattgcgcggaactttatttcaactacttgatggacaaccacaagcggctcggcatcaatctgaccgacatcaagcggtcaatgcagctgataggagatattcttgatgtcgaggtcaatcattacctgaaagatttttctttgtcgaatgtgacgctttggatgagccaggagaaa

SEQ ID NO: 11 - DNA, 672 bp, Bacillus subtilis
atgaagatttacggagtatatatggaccgcccgctttctgcaggggaagaggatcggatgatggcggccgtgtccgccgaaaagcgggaaaaatgccggcgcttttaccataaggaggatgctcaccgcaccttgatcggcgacatgctgatccgcaccgctgcggcgaaggcttacggacttgatccggccgggatttcattcggcgtccaggaatacggaaagccgtacatccccgcgcttccggacatgcactttaacatttcccactccgggcgctggatcgtgtgcgccgttgattcaaaaccgatcggcattgatattgaaaaaatgaagcccggcacgattgatatcgccaaacggtttttttcgccgacggaatacagtgatctgcaagcgaaacaccccgatcagcagaccgattatttttaccatctgtggtcgatgaaagaaagctttatcaagcaggccggaaaagggctttccctgccgcttgattcattcagcgtccgccttaaagacgacggccatgtgtccattgagctcccggacggacatgaaccttgtttcatccgcacatatgatgcggacgaggagtataagctggccgtttgtgcggcgcatcccgatttttgtgacgggattgagatgaaaacgtatgaaaagctgctg

SEQ ID NO: 12 - DNA, 1791 bp, Bacillus subtilis
atgatttttgcattggatacgtatctcgttttactttccgttgttataggatatcaattttttgaggattcttatcacttttatgactccggagcgttgctgctgactgccgtgagcatgttgatcagccatcatgtatgcgcttttatgtttcaccagtataagcaggtatggacgtacacgggaataggcgagctgcttgatctgctgaaggggatcacgctgtccgcagctgtgacagccgccgtccaatacggggtgttccacacgattttgttccggctgttggccgtcagctggatggttcagctattgttcatcggaggaagccggatgatttcacgggtgctgaaagaaacgatcggcaggaagcaaaatgactcttcccgggcgctgatcatcggcgcaggtgcgggagggacgctgctcgtccgtcagcttacccagaaaaacgatctcggaatcatgcctgtggcttttattgatgatgatcagacaaagcataagcttgaaatcatgggcctgcccgtcatcggcggaaaagaaagcattatgccggcggtgcagaggctgagaattcaccatatcatcattgccattccgtctctttgcacccatgagcttcagacgttatacaaagaatgtgtgcagacgggcgcccatattaaaatcatgccgcaatttgatgagatcctgctcggaacgcaggctgccggacacatcagagatgtaaaagccgaagatctgctcggcagaaagccggtcacccttgatacgagcaaaatttctgacagcatcaagggaaaaacgattctggtcacgggcgccggcggctcaatcggttctgagatctgccgccagatcagcgcgtttcttccgcgggaaatcgtccttctcggccacggggagaacagcattcattccgtacataccgagctgtccgcacgcttcggcaaagaggtgctctttcacgcggagatcgccgatattcaggacagagataaaatctttgctttgatgaaaaaatacgagccgcacgtcgtctatcatgcggctgcccataaacatgtgccgttaatggaacataatccggaagaagccgttaaaaacaacattatcggcacgaaaaatgtcgccgaagccgccgacatgtgcggaacggaaacattcgtgctgatttcttctgacaaagcggtcaatccggccaatgtcatgggcgcgacgaaacggtttgcggaaatggtcatcatgaacctcggaaaggtcagcagcaccaaattcgccgccgtccgtttcggaaatgtgctcggaagccgcggcagcgtcattccgattttcaaaaagcagattgaaaaaggcggacccgtcaccgtcacgcacccggcgatgacaagatattttatgacgattcccgaagcgtcaagactcgtcattcaggcgggggcgcttgcaaaagggcggcagattttcgttctggatatgggagaacccgtcaaaatcgtcgatctggccaaaaacctgattcatttatcaggctatacgacagaacagattcccatcgaattctccggcatccgtccgggagaaaagatgtatgaagaattgctgaatcataatgaagtacatacggagcagatttttccgaaaatccatatcgggaaagcggtggacgggaattgggccgtactcatccgttttatggaggaattcagccgtctgcctgaagaagagctgagaaaaaggctgtttgaggcgatcgaatcagtacatgaagaagcggccgcaggcgtg

SEQ ID NO: 13 - DNA, 138 bp, Bacillus subtilis
gtggaaaacaaattagaagaagtaaagcaattattattccgacttgaaaatgatatcagagaaacaaccgactcattacgaaacattaacaaaagcattgatcagctcgataaattctcatatgcaatgaaaatttct

SEQ ID NO: 14 - DNA, 352 bp, Bacillus subtilis
ttgaagagggcaagtattgtgcgtgaaaaaaaaatattatgaattagtggaacaattaaaagacagaacacaagacgtaacattttcagctacaaaagcactaagtcttcttatgctgttcagcagatatttggtcaattacaccaatgtcgaatcagtaaatgacattaatgaggaatgcgccaaacattattttaactacttaatgaaaaaccataagcgattaggaattaatctgacagatataaaaaggtcgatgcatctaatcagcgggttattggatgtggatgtaaaccactatttaaaggatttttcactatcgaatgtcacgctgtggatgacgcaagagaga

SEQ ID NO: 15 - protein, 117 aa, Bacillus amyloliquefaciens
MKRASIVREKKYYELVEQLKDRTKDVTFSSTKALSLLMLFSRYLVNYTNVECVHDINEECAKHYFTYLMKNHKRLGINLTDIKRSMLLISGVIEVEVDHYLKDFSLSNVTLWMTEER

SEQ ID NO: 16 - protein, 117 aa, Bacillus subtilis
  misc_feature (115)..(115): Xaa can be any naturally occurring amino acid
MKRASIVREKKYYELVEQLKDRTQDVTFSATKALSLLMLFSRYLVNYTNVESVNDINEECAKHYFNYLMKNHKRLGINLTDIKRSMHLISGLLDVDVNHYLKDFSLSNVTLWMTXER

SEQ ID NO: 17 - protein, 117 aa, Bacillus atrophaeus
MKRASIVREKKYYELVEQLKDRTQDVTFSATKALSLLMLFSRYLVNYTNVESVNDINEECAEHYFNYLMKNHKRLGINLTDIKRSMLLIGGVLDVEVNHYLKDFSLSNVTLWMNQER

SEQ ID NO: 18 - protein, 117 aa, Bacillus pumilus
MKRASIVREKKYYELVEELKSRTKDVTFSATKALSLLMLLSRYLVNYTTVESVDEIDEDCAEIYFNYLMDNHKRLGINLTDIKRSMQLLGGILDVDVNHYLKDFSLSNVTLWMNQEK

SEQ ID NO: 19 - protein, 117 aa, Bacillus pumilus
MKRASIVREKKYYELVEELKSRSKDVTFSATKALSLLMLLSRYLVNYTTVESVDEIDEDCAEIYFNYLMDNHKRLGINLTDIKRSMQLLGGILDVDVNHYLKDFSLSNVTLWMNQEK

SEQ ID NO: 20 - protein, 117 aa, Bacillus licheniformis
MKRASIVREKKYYELVEQLKVRSQDVTFSATKAVGLLMLFSRYLVNYTSVESVEDINEDCAELYFNYLMDNHKRLGINLTDIKRSMQLIGDILDVEVNHYLKDFSLSNVTLWMSQEK